(19) United States
(12) Patent Application Publication
(10) Pub. No.: US 2003/0223602 A1
(43) Pub. Date: Dec. 4, 2003

(54) Method and system for audio imaging

(75) Inventors: Uzi Eichler, Haifa (IL); Lior Barak, Haifa (IL); Avner Paz, Reut (IL)

Correspondence Address: TESTA, HURWITZ & THIBEAULT, LLP, HIGH STREET TOWER, 125 HIGH STREET, BOSTON, MA, 02110, US

(73) Assignee: Elbit Systems Ltd., Haifa (IL)

(21) Appl. No.: 10/162,231

(22) Filed: Jun. 4, 2002

(51) Int. Cl. H04R 5/02; H04R 1/10

(52) U.S. Cl. 381/309; 381/74; 455/575.2

(57) ABSTRACT

System for producing multi-dimensional sound to be heard by an aircraft crew member, the multi-dimensional sound being respective of an input signal received from a source and associated with a respective indicated input signal position, the system comprising an aircraft crew member position system, detecting the aircraft crew member position, a memory unit, storing a plurality of spatial sound models, a processor, coupled with the aircraft crew member position system, the memory unit and with the source, the processor retrieving a selected one of the spatial sound models from the memory unit, according to the indicated input signal position and the aircraft crew member position, the processor applying the selected spatial sound model to an audio signal respective of the input signal, thereby producing a plurality of audio channels, and a plurality of head-mounted sound reproducers, coupled with the processor, each the head-mounted sound reproducers being associated with and producing sound according to a respective one of the audio channels.

### FIELD OF THE DISCLOSED TECHNIQUE

The disclosed technique relates to audio reproduction in general, and to methods and systems for three dimensional audio imaging, in particular.

### BACKGROUND OF THE DISCLOSED TECHNIQUE

In contemporary aircraft cockpit configurations, a crew member receives both auditory and visual inputs pertaining to flight conditions, aircraft conditions, warnings, and alarms. The crew member (e.g. pilot, navigator, flight engineer, and the like) further receives audio input from neighboring aircraft, ground forces, and ground control which are in radio communication with the crew member. Audio input is usually received via headphones which are incorporated into the flight helmet, worn by the crew member. The headphones provide the audio input to the listener in an omni-directional manner.

U.S. Pat. No. 4,118,599 issued to Iwahara, et al., and entitled “Stereophonic Sound Reproduction System”, is directed to a system and method for converting a monaural audio signal to a binaural signal which contains virtual sound sources located at a desired position at the listening area. This reference further discloses a crosstalk cancellation converter for minimizing the effect of crosstalk between the left and right reproduced signals, when reproducing the binaural sound. The system operates by applying separate frequency response and delay characteristics for each of the left and right channels, to create the effect produced by a localized sound source, located at the desired location. A crosstalk cancellation filter is then used on each of the left and right channels, modifying the signals to minimize crosstalk, there between.

U.S. Pat. No. 5,809,149 issued to Cashion, et al., and entitled “Apparatus for Creating 3D Audio Imaging Over Headphones Using Binaural Synthesis”, is directed to an apparatus for controlling an apparent location of a sound source using headphones. Furthermore, the apparatus causes the apparent source to move with smooth transitions during the sound reproduction. This reference discloses a method for simulating source position by controlling magnitude and delay values for reproduced sounds, using multiple audio signals to reproduce the different apparent sound waves. This reference further discloses storing calculated azimuth and range, delay and amplitude values in a look-up table, and using the stored values to perform the sound reproduction. This reference further discloses a method for minimizing the number of frequency filters employed, by interpolating between several predetermined filters.

U.S. Pat. No. 5,438,623 issued to Begault and entitled “Multi-Channel Spatialization System for Audio Signals”, is directed to a method for imposing spatial cues to a plurality of audio signals, using head related transfer functions (HRTF), such that each audio signal may be heard at a different spatial location about the head of a listener. The method operates by using stored positional and HRTF data in a non-volatile memory, by converting the audio signals to digital format, applying the stored HRTF, reconverting the signal to analog format and reproducing the signal using headphones.

This reference further discloses a method for generating synthetic HRTF by storing measured HRTF and position data for each ear, and performing a Fast Fourier Transform of the data, resulting in an analysis of the magnitude of the response for each frequency. Following this, a weighting value is supplied for each frequency and magnitude derived from the Fast Fourier Transform. Finally, the values are supplied to a well known Parks-McClelland finite impulse response (FIR) linear phase filter design algorithm. Such an algorithm is disclosed in J. H. McClellend et al (1979) “FIR Linear Phase Filter Design Program”, Programs For Digital Signal Processing, (pp.5.1-1-5.1-13), New York: IEEE Press and is readily available in several filter design software packages. This algorithm permits a setting for the number of coefficients used to design a filter having a linear phase response. A Remez exchange program included therein is also utilized to further modify the algorithm such that the supplied weights in the weight column, determine the distribution across frequency of the filter error ripple.

Methods for detecting a helmet position and orientation are well known in the art. U.S. Pat. No. 5,646,525 issued to Gilboa and entitled “Three Dimensional Tracking System Employing a Rotating Field”, is directed to an apparatus for detecting the position and orientation of a helmet worn by a crew member in a vehicle. The apparatus provides a set of rotating electric and magnetic fields associated with the vehicle and a plurality of detectors associated with the helmet. The apparatus further provides calculation circuitry which determines the position of the detectors with respect to the field. By providing three orthogonal detectors, the position and orientation of the helmet, and thus the line-of-sight and head position of the crew member, may be inferred.

U.S. Pat. No. 5,802,180 issued to Abel et al., and entitled “Method and Apparatus for Efficient Presentation of High-Quality Three-Dimensional Audio Including Ambient Effects”, is directed to a system for reproducing an output audio signal, according to the desired direction of the source of an input audio signal and the position and orientation of a listener. The system includes a plurality of first input amplifiers, a plurality of second input amplifiers, a plurality of first output amplifiers, a plurality of second output amplifiers, a plurality of first input combiners, a first output combiner, a second output combiner and a plurality of filters.

Each of two respective ones of the first input amplifiers and the second input amplifiers are coupled with a respective one of the input combiners. Each of the input combiners is coupled with the respective ones of the filters. Each of the two respective ones of the first output amplifiers and the second output amplifiers are coupled with the respective ones of the filters. The first output amplifiers are coupled with the first output combiner and the second output amplifiers are coupled with the second output combiner.

The first input amplifiers receive a first input audio signal and a first direction signal respective of the desired direction of the source of the first input audio signal. The second input amplifiers receive a second input audio signal and a second direction signal respective of the desired direction of the source of the second input audio signal. The first output amplifiers receive a first location and orientation signal respective of a first ear of a listener and the second output amplifiers receive a second location and orientation signal respective of a second ear of the listener. The first output combiner and the second output combiner produce a first output audio signal and a second output audio signal, respectively, according to the first and the second audio signals, the first and the second direction signals and the first and the second location and orientation signals.

U.S. Pat. No. 5,946,400 issued to Matsuo and entitled “Three-Dimensional Sound Processing System”, is directed to a system for reproducing an audio signal according to the location of the source of the audio signal relative to the listener, and the distance and the moving speed of the source relative to the listener. The system includes enhancement means, memory means, a sound image positioning filter, motion speed calculation means, speed coefficient decision means, a filter, distance calculation means, distance coefficient decision means, and a low-pass filter.

The memory means is coupled with the enhancement means and with the sound image positioning filter. The filter is coupled with the sound image positioning filter, the speed coefficient decision means and with the low-pass filter. The motion speed calculation means is coupled with the distance calculation means and with the speed coefficient decision means. The distance coefficient decision means is coupled with the low-pass filter and with the distance calculation means.

The enhancement means generates in advance, two difference-enhanced impulse responses, respective of two sound paths originating from a sound source and reaching the right and the left ear of the listener. The memory means determines a set of filter coefficients, according to the difference-enhanced impulse responses. The low-pass filter receives the audio signal and each of the distance calculation means and the memory means, receives a location signal respective of the location of the source of the audio signal.

The distance calculation means calculates the distance of the listener from the source, according to the location signal and the distance coefficient means determines a distance coefficient according to the calculated distance. The low-pass filter produces a low-pass filtered audio signal, by suppressing the high frequencies of the audio signal, according to the distance coefficient. The motion speed calculation means determines the speed of the source according to the location signal and the speed coefficient decision means determines a speed coefficient according to the determined speed. The filter produces a Doppler filtered audio signal by suppressing either the low or the high frequencies of the low-pass filtered audio signal, according to the speed coefficient.

The memory means determines a set of location coefficients according to the location signal, wherein each location coefficient corresponds to the location of the source relative to the ears of the listener. The sound image positioning filter produces an output audio signal, by applying the set of location coefficients to the Doppler filtered audio signal.

U.S. Pat. No. 6,243,476 issued to Gardner and entitled “Method and Apparatus for Producing Binaural Audio for a Moving Listener”, is directed to a system for producing three-dimensional sound from a pair of loudspeakers, for a moving listener. The system includes a binaural synthesis module, a crosstalk cancellation unit, a pair of loudspeakers, a video camera, a tracking unit and a storage unit. The binaural synthesis module produces binaural audio signals according to the location and orientation of a listener relative to the source of input audio signals. The crosstalk cancellation unit produces crosstalk cancelled signals, which cancel the acoustic effect of each pair of the loudspeakers on each ear of the listener. The crosstalk cancellation unit employs a transfer function which takes into account the speaker frequency response, air propagation and the head response.

The storage unit is coupled with the tracking unit, the binaural synthesis module and with the crosstalk cancellation unit. The crosstalk cancellation unit is coupled with the binaural synthesis module and with the pair of loudspeakers. The tracking unit is coupled with the video camera and with the storage unit.

The tracking unit derives the position of the moving listener and the rotation angle of the head of the moving listener relative to the pair of loudspeakers, according to video signals received from the video camera and produces tracking data. The storage unit receives the tracking data from the tracking unit and selects appropriate tracking values for the binaural synthesis module and the crosstalk cancellation unit. The binaural synthesis module produces the binaural audio signals according to the input audio signals and the tracking values. The crosstalk cancellation unit produces the crosstalk cancelled signals according to the tracking values and the binaural audio signals and the pair of loudspeakers produce sound according to the crosstalk cancelled signals.

### SUMMARY OF THE DISCLOSED TECHNIQUE

It is an object of the disclosed technique to provide a novel method and system for three dimensional audio imaging, which overcomes the disadvantages of the prior art.

In accordance with the disclosed technique, there is thus provided a system for producing multi-dimensional sound to be heard by an aircraft crew member. The multi-dimensional sound is respective of an input signal received from a source and associated with a respective indicated input signal position. The system includes an aircraft crew member position system, a memory unit, a processor, and a plurality of head-mounted sound reproducers. The processor is coupled with the aircraft crew member position system, the memory unit, and with the plurality of head-mounted sound reproducers. The aircraft crew member position system detects the aircraft crew member position. The memory unit stores a plurality of spatial sound models. The processor retrieves a selected one of the spatial sound models from the memory unit, according to the indicated input signal position and the aircraft crew member position. The processor applies he selected spatial sound model to an audio signal respective of the input signal, thereby producing a plurality of audio channels. Each of the head-mounted sound reproducers is associated with and produces sound according to a respective one of the audio channels.

In accordance with another aspect of the disclosed technique, there is thus provided a method for producing multi-dimensional sound to be heard by an aircraft crew member. The method includes the procedures of detecting a listening position of the aircraft crew member, selecting a spatial sound model, applying the selected spatial sound model to an audio signal thereby producing a plurality of audio signals, and producing the multi-channel sound by a plurality of head-mounted sound reproducers. The spatial sound model is selected according to the detected listening position and an indicated audio signal position. The multi-channel sound is produced according to the audio signals.

In accordance with a further aspect of the disclosed technique, there is provided a system for producing multi-dimensional sound in an aircraft, the multi-dimensional sound being respective of at least one input signal received from at least one source and associated with a respective indicated input signal position. The system includes a memory unit, a processor, and a plurality of sound reproducers. The processor is coupled with the memory unit and with the source, and the plurality of sound reproducers. The memory unit stores a plurality of spatial sound models. The processor retrieves a selected one of the sound models from the memory unit, according to the indicated input signal position. The processor applies the selected spatial sound model to an audio signal respective of the input signal, thereby producing a plurality of audio channels. The sound reproducers are located at substantially fixed positions within the aircraft, each of the sound reproducers being associated with and producing sound according to a respective one of the audio channels.

### BRIEF DESCRIPTION OF THE DRAWINGS

The disclosed technique will be understood and appreciated more fully from the following detailed description taken in conjunction with the drawings in which:

FIG. 1 is a schematic illustration of an apparatus, constructed and operative in accordance with an embodiment of the disclosed technique;

FIG. 2 is a schematic illustration of a crew member helmet, constructed and operative in accordance with another embodiment of the disclosed technique;

FIG. 3 is a schematic illustration of an aircraft, wherein examples of preferred virtual audio source locations are indicated;

FIG. 4 is a schematic illustration of an aircraft formation, using radio links, to transmit audio signals between crew members in the different aircrafts; and

FIG. 5 is a schematic illustration of a method for three dimensional (3D) audio imaging, based on line-of-sight measurements, operative in accordance with a further embodiment of the disclosed technique.

### DETAILED DESCRIPTION OF THE EMBODIMENTS

The disclosed technique overcomes the disadvantages of the prior art by providing a system and a method which produce three dimensional audio imaging, through the headphones of a helmet worn by a crew member. The disclosed technique enables the crew member to immediately associate a spatial location with audio signals which she receives while piloting the aircraft.

The term “position” herein below, refers either to the location, to the orientation or both the location and the orientation, of an object in a three dimensional coordinate system. The term “aircraft” herein below, refers to airplane, helicopter, amphibian, balloon, glider, unmanned aircraft, spacecraft, and the like. It is noted that the disclosed technique is applicable to aircraft as well as devices other than aircraft, such as ground vehicle, marine vessel, aircraft simulator, ground vehicle simulator, marine vessel simulator, virtual reality system, computer game, home theatre system, stationary units such as an airport control tower, portable wearable units, and the like.

For example, the disclosed technique can provide an airplane crew member three dimensional audio representation regarding another aircraft flying nearby, a moving car and ground control. Similarly, the disclosed technique can provide a flight controller at the control tower three dimensional audio representation regarding aircrafts in the air or on the ground, various vehicles and people in the vicinity of the airport, and the like.

In a simple example, alerts pertaining to aircraft components situated on the left aircraft wing, are imbued with a spatial location corresponding to the left side of the aircraft. This allows the crew member to immediately recognize and concentrate on the required location.

In another example, when a plurality of aircrafts are flying in formation, and are in radio communication, a system according to the disclosed technique associates a received location for each audio signal transmission, based on the location of the transmitting aircraft, relative to the receiving aircraft. For example, when the transmitting aircraft is located on the right side of the receiving aircraft, the system provides the transmission of sound to the crew member of the receiving aircraft, as if it was coming from the right side of the aircraft, regardless of the crew member head position and orientation. Thus, if the crew member is looking toward the front of the aircraft, then the system causes the sound to be heard on the right side of the helmet, while if the crew member is looking toward the rear of the aircraft, the system causes the sound to be heard on the left side of the helmet.

Such spatial association is performed by imbuing the audio signals with spatial location characteristics, and correlating the imbued spatial location with the actual spatial location or with a preferred spatial location. The actual spatial location relates to the location of the sound source relative to the receiving crew member. For example, when the transmitting aircraft is flying to the upper right of the receiving aircraft, a system according to the disclosed technique imbues the actual location of the transmitting aircraft (i.e., upper right) to the sound of the crew member of the transmitting aircraft, while reproducing that sound at the ears of the crew member of the receiving aircraft.

The preferred spatial location refers to a location which is defined virtually to provide a better audio separation of audio sources or to emphasize a certain audio source. For example, when different warning signals are simultaneously generated at the right wing of the aircraft, such as engine fire indication (signal S₁), extended landing gear indication (signal S₂) and a jammed flap indication (signal S₃), a system according to the disclosed technique imbues a different spatial location on each of these warning signals. If the spherical orientation (φ,θ) of the right side is designated (0,0), then a system according to the disclosed technique shall imbue orientations (0,30°), (0,−30°) and (30°,0) to signals S₁, S₂ and S₃, respectively. In this case, the crew member can distinguish these warning signals more easily. It is noted that the disclosed technique localizes a sound at a certain position in three dimensional space, by employing crew member line-of-sight information.

The human mind performs three dimensional audio location, based on the relative delay and frequency response of audio signals, between the left and the right ear. By artificially introducing such delays and frequency response, a monaural signal, is transformed into a binaural signal, having spatial location characteristics. The delay and frequency response which associate a spatial audio source location with each ear are described by a Head Related Transfer Function (HRTF) model. The technique illustrated may be refined by constructing the HRTF models for each individual, taking into account different head sizes and geometries. The human ability to detect the spatial location of a sound source by binaural hearing, is augmented by head movements, allowing the sound to be detected in various head orientations, increasing localization efficiency.

In a cockpit environment, a crew member does not maintain a fixed head orientation, but rather, changes head orientation according to the tasks performed. The disclosed technique takes into account the present crew member head orientation, by determining a suitable HRTF model based on both the actual source location, and the crew member head orientation. The crew member head orientation is detected by a user position system. The user position system includes units for detecting the user position (e.g., line-of-sight, ears orientation) and can further include units, such as a GPS unit, a radar and the like, for detecting the position of a volume which is associated with the user (e.g., a vehicle, a vessel, an aircraft and the like). The user position system can be user head-mounted (e.g., coupled to a head-mounted device, such as a helmet, headset, goggles, spectacles) or remote from the user (e.g., one or more cameras overlooking the user, a sonar system). Units for detecting the position of that volume can be coupled with the volume (e.g., GPS unit, onboard radar unit) or be external to the volume (e.g., ground IFF-radar unit with wireless link to the aircraft). Such volume position detecting units can be integrated with the user position detecting units. The user position system can be in form of an electromagnetic detection system, optical detection system, sonar system, and the like.

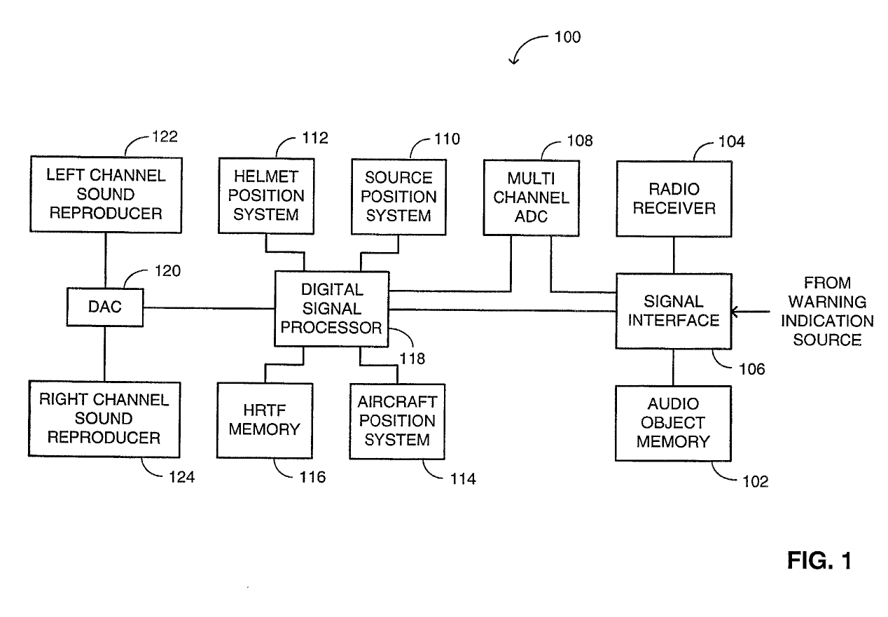

Reference is now made to FIG. 1, which is a schematic illustration of a system, generally referenced 100, constructed and operative in accordance with an embodiment of the disclosed technique. System 100 includes an audio object memory 102, a radio receiver 104, a signal interface 106 (e.g., a signal multiplexer), a multi channel analog to digital converter (ADC) 108, a source position system 110, an aircraft position system 114, an HRTF memory 116, a helmet position system 112, a digital signal processor 118, a digital to analog converter (DAC) 120, a left channel sound reproducer 122, and a right channel sound reproducer 124. Audio object memory 102 includes audio signal data and position data respective of a plurality of alarm states.

Signal interface 106 is coupled with audio object memory 102, radio receiver 104, digital signal processor 118 and with multi channel ADC 108. Multi channel ADC 108 is further coupled with digital signal processor 118. Digital signal processor 118 is further coupled with source position system 110, helmet position system 112, aircraft position system 114, source location (HRTF) memory 116 and with DAC 120. DAC 120 is further coupled with left channel sound reproducer 122 and with right channel sound reproducer 124.

Radio receiver 104 receives radio transmissions in either analog or digital format and provides the audio portion of the radio transmissions to signal interface 106. Signal interface 106 receives warning indications from a warning indication source (not shown), such as an aircraft component, onboard radar system, IFF system, and the like, in either analog or digital format. Signal interface 106 receives audio data and spatial location data in digital format, respective of the warning indication, from audio object memory 102.

If the signals received by signal interface 106 are in digital format, then signal interface 106 provides these digital signals to digital signal processor 118. If some of the signals received by signal interface 106 are in analog format and others in digital format, then signal interface 106 provides the digital signals to digital signal processor and the analog ones to multi channel ADC 108. Multi channel ADC 108 converts these analog signals to digital format, multiplexes the different digital signals and provides these multiplexed digital signals to digital signal processor 118.

Source position system 110 provides data respective of the radio source location to digital signal processor 118. Helmet position system 112 provides data respective of crew member helmet position to digital signal processor 118. Aircraft position system 114 provides data respective of current aircraft location to digital signal processor 118. Digital signal processor 118 selects a virtual source location based on the data respective of radio source location, crew member helmet position, and current aircraft location. Digital signal processor 118 then retrieves the appropriate HRTF model, from HRTF memory 116, based on the selected virtual source location.

Digital signal processor 118 filters the digital audio signal, using the retrieved HRTF model, to create a left channel digital signal and a right channel digital signal. Digital signal processor 118 provides the filtered digital audio signals to DAC 120.

DAC 120 converts the left channel digital signal and the right channel digital signal to analog format, to create a left channel audio signal and a right channel audio signal, respectively, and provides the audio signals to left channel sound reproducer 122 and right channel sound reproducer 124. Left channel sound reproducer 122 and right channel sound reproducer 124, reproduce the analog format left channel audio signal and right channel audio signal, respectively.

When an alarm or threat is detected, audio object memory 102 provides the relevant audio alarm to multi channel ADC 108, via signal interface 106. Multi channel ADC 108 converts the analog audio signal to digital format and provides the digital signal to digital signal processor 118.

Helmet position system 112 provides data respective of crew member helmet position to digital signal processor 118. Aircraft position system 114 provides data respective of current aircraft location to digital signal processor 118. Aircraft position system 114 is coupled with the aircraft. Digital signal processor 118 selects a virtual source location based on the data respective of threat, alarm or alert spatial location, crew member helmet position, and current aircraft location. Digital signal processor 118 then retrieves the appropriate HRTF model, from HRTF memory 116, based on the selected virtual source location, in accordance with the embodiment illustrated above.

It is noted that helmet position system 112 can be replaced with a location system or an orientation system. For example, when the audio signal is received from a transmitting aircraft, then the orientation of the helmet and the location of the receiving aircraft relative to the transmitting aircraft, is more significant than the location of the helmet within the cockpit of the receiving aircraft. In this case, the location of the transmitting aircraft relative to the receiving aircraft can be determined by a global positioning system (GPS), a radar system, and the like.

It is noted that radio receiver 104 is the radio receiver generally used for communication with the aircraft, and may include a plurality of radio receivers, using different frequencies and modulation methods. It is further noted that threat identification and alarm generation are performed by components separate from system 100 which are well known in the art, such as IFF (Identify Friend or Foe) systems, ground based warning systems, and the like. It is further noted that left channel sound reproducer 122 and right channel sound reproducer 124, are usually headphones embedded in the crew member helmet, but may be any other type of sound reproducers known in the art, such as surround sound speaker systems, bone conduction type headphones, and the like.

According to another embodiment of the disclosed technique, audio object memory 102 stores audio alarms in digital format, eliminating the need for conversion of the audio signal to digital format, before processing by digital signal processor 118. In such an embodiment, audio object memory 102 is directly coupled with digital signal processor 118.

According to a further embodiment of the disclosed technique, radio receiver 104 may be a digital format radio receiver, eliminating the need for conversion of the audio signal to digital format, before processing by digital signal processor 118. Accordingly, radio receiver 104, is directly coupled with digital signal processor 118.

According to another embodiment of the disclosed technique, helmet position system 112, may be replaced by a crew member line-of-sight system (not shown), separate from a crew member helmet (not shown). Accordingly, the crew member may not necessarily wear a helmet, but may still take advantage of the benefits of the disclosed technique. For example, a crew member in a commercial aircraft normally does not wear a helmet. In such an example, the crew member line-of-sight system may be affixed to the crew member head, for example via the crew member headphones, in such a way so as to provide line-of-sight information.

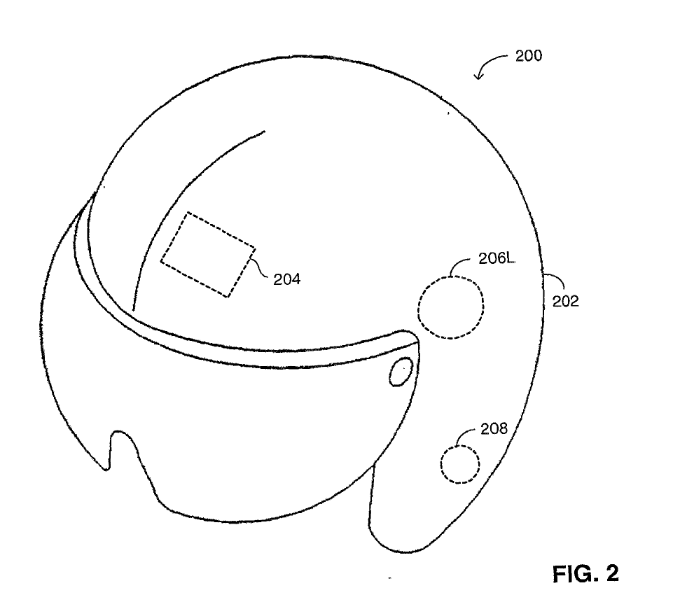

Reference is now made to FIG. 2, which is a schematic illustration of a crew member helmet, generally referenced 200, constructed and operative in accordance with a further embodiment of the disclosed technique. Crew member helmet 200 includes a helmet body 202, a helmet line-of-sight system 204, a left channel sound reproducer 206L, a right channel sound reproducer (not shown) and a data/audio connection 208. Helmet line-of-sight system 204, left channel sound reproducer 206L, the right channel sound reproducer, and data/audio connection 208 are mounted on helmet body 202. Data/audio connection 208 is coupled with helmet line-of-sight system 204, left channel sound reproducer 206L, and the right channel sound reproducer.

Helmet line-of-sight system 204, left channel sound reproducer 206L and the right channel sound reproducer, are similar to helmet position system 112 (FIG. 1), left channel sound reproducer 122 and right channel sound reproducer 124, respectively. Helmet line-of-sight system 204, left channel sound reproducer 206L and the right channel sound reproducer, are coupled with the rest of the three dimensional sound imaging system elements (corresponding to the elements of system 100 of FIG. 1) via data/audio connection 208.

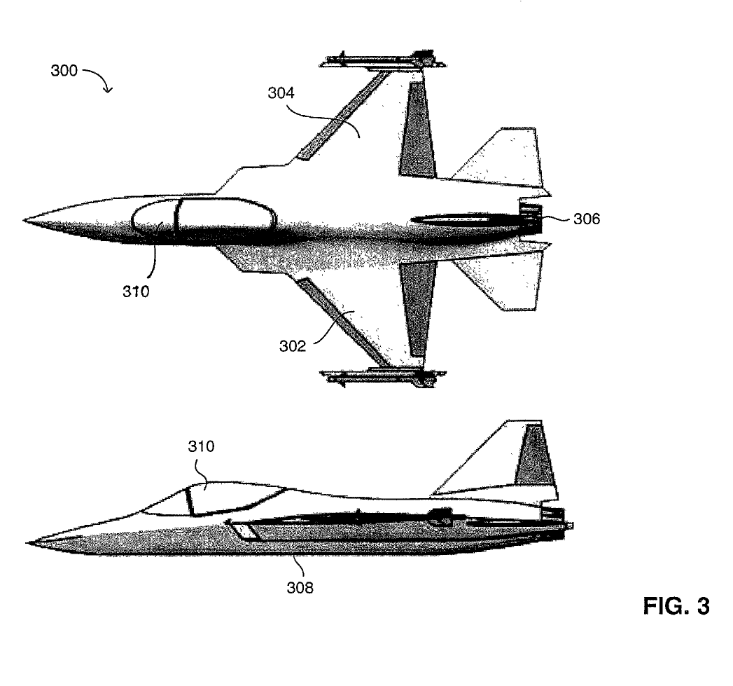

Reference is now made to FIG. 3, which is a schematic illustration of an aircraft, generally referenced 300, wherein examples of preferred virtual audio source locations are indicated. Indicated on aircraft 300 are, left wing virtual source location 302, right wing virtual source location 304, tail virtual source location 306, underbelly virtual source location 308, and cockpit virtual source location 310. In general, any combination of location and orientation of a transmitting point with respect to a receiving point, can be defined for any transmitting point surrounding the aircraft, using Cartesian coordinates, spherical coordinates, and the like. Alerts relating to left wing elements, such as left engine, left fuel tank and left side threat detection, are imbued with left wing virtual source location 302, before transmission to the crew member. In a further example, alerts relating to the aft portion of the aircraft, such as rudder control alerts, aft threat detection, and afterburner related alerts, are imbued with tail virtual source location 306, before being transmitted to the crew member.

It is noted that the illustrated virtual source locations, are merely examples of possible virtual source locations, provided to illustrate the principles of the disclosed technique. Other virtual source location may be provided, as required.

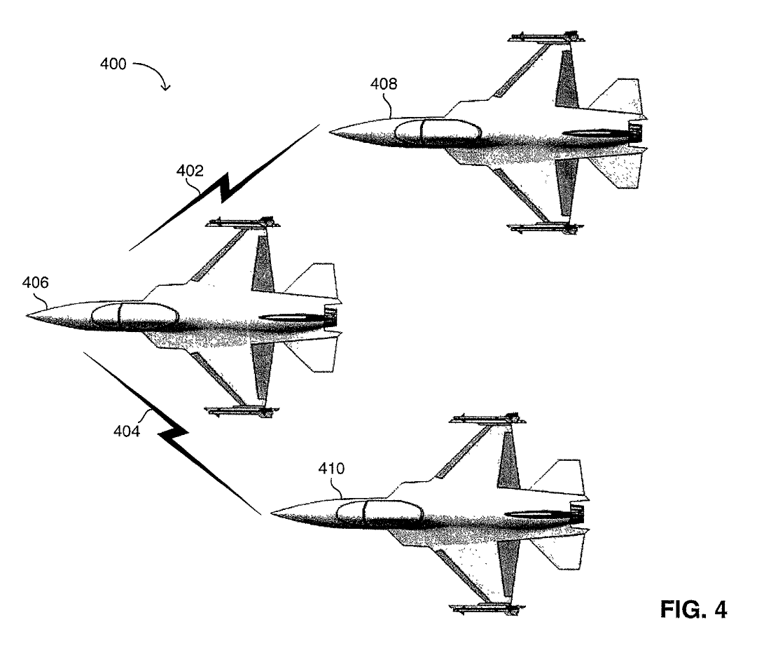

Reference is now made to FIG. 4, which is a schematic illustration of an aircraft formation, generally referenced 400, using radio links, to communicate audio signals between crew members in the different aircrafts. Aircraft formation 400 includes lead aircraft 406, right side aircraft 408, and left side aircraft 410. The aircrafts in aircraft formation 400 communicate there between via first radio link 402, and second radio link 404. Lead aircraft 406 and right side aircraft 408, are in communication via first radio link 402. Lead aircraft 406 and left side aircraft 410, are in communication via second radio link 404.

In accordance with the disclosed technique, when lead aircraft 406, receives a radio transmission from right side aircraft 408 via first radio link 402, the received radio transmission is imbued with a right rear side virtual source location, before being played back to the crew member in lead aircraft 406. In another example, when left side aircraft 410 receives a radio transmission from lead aircraft 406, via second radio link 404, the received radio transmission is imbued with a right frontal side virtual source location, before being played back to the crew member in left side aircraft 410.

It is noted that the illustrated virtual formation, is merely an example of a possible formation and radio links, provided to illustrate the principles of the disclosed technique. Other formation and radio links, corresponding to different virtual source locations, may be employed, as required.

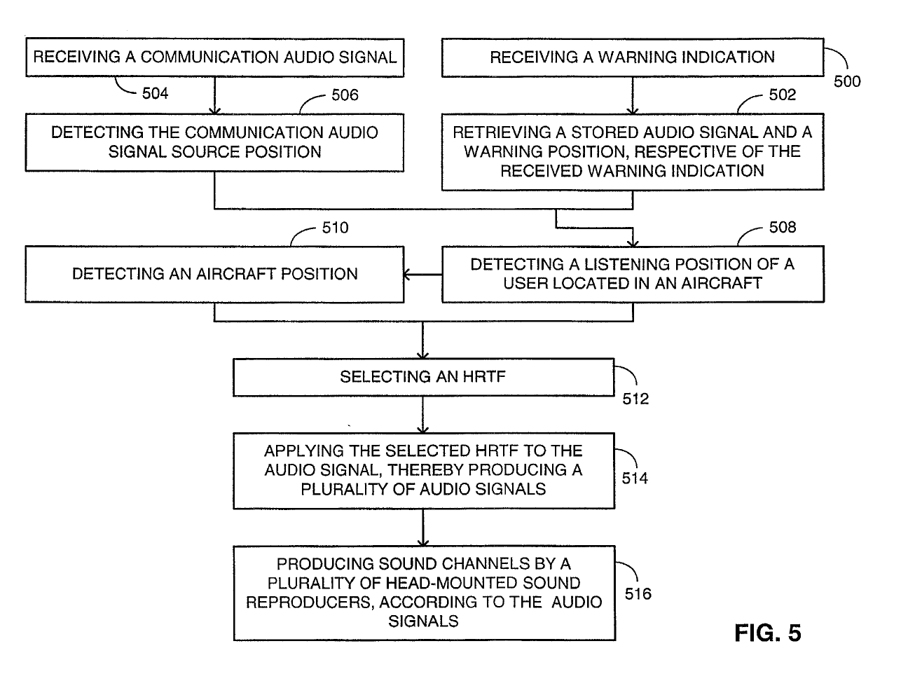

Reference is now made to FIG. 5, which is a schematic illustration of a method for 3D audio imaging, based on line-of-sight measurements, operative in accordance with a further embodiment of the disclosed technique. In procedure 500, a warning indication is received. The warning indication is respective of an event, such as a malfunctioning component, an approaching missile, and the like. With reference to FIG. 1, digital signal processor 118 receives a warning indication from an aircraft component (not shown), such as fuel level indicator, landing gear position indicator, smoke indicator, and the like. Alternatively, the warning indication is received from an onboard detection system, such as IFF system, fuel pressure monitoring system, structural integrity monitoring system, radar system, and the like.

For example, in a ground facility, an alarm system according to the disclosed technique, provides warning indication, respective of a moving person, to a guard. In this case, the alarm system provides the alert signal (e.g., silent alarm) respective of the position of the moving person (e.g., a burglar), with respect to the position of the guard, so that the guard can conclude from that alert signal, where to look for that person.

In procedure 502, a stored audio signal and a warning position respective of the received warning indication, is retrieved. For each warning indication, a respective audio signal and a respective spatial position is stored in a memory unit. For example, a jammed flap warning signal on the right wing is correlated with beep signals at 5 kHz, each at 500 msec duration and 200 msec apart and with an upper right location of the aircraft. With reference to FIGS. 1 and 3, digital signal processor 118 retrieves an audio signal respective of a low fuel tank in the left wing of aircraft 300, and left wing virtual source location 302, from audio object memory 102. Alternatively, when a warning regarding a homing missile is received from the onboard radar system, digital signal processor 118 retrieves an audio signal respective of a homing missile alert, from audio object memory 102. The system associates between that audio signal and the position of that missile as provided by the onboard radar system so as when selecting the appropriate HRTF, to provide the user with a notion of where the missile is coming from.

In procedure 504, a communication audio signal is received. The communication audio signal is generally associated with voice (e.g., the voice of another person in the communication network). With reference to FIG. 1, radio receiver 104 receives a communication audio signal. The communication audio signal can be received from another crew member in the same aircraft, from another aircraft flying simultaneously, from a substantially stationary source relative to the receiving aircraft, such as a marine vessel, air traffic controller, ground vehicle, and the like. Communications audio signal sources can, for example, be ground forces communication radio (Aerial Support), UHF radio system, VHF radio system, satellite communication system, and the like.

In procedure 506, the communication audio signal source position, is detected. This detected position defines the position of a speaking human in a global coordinate system. With reference to FIG. 1, if the communication audio signal is received from a crew member in the same aircraft, then source position system 110 detects the location of the helmet of the transmitting crew member. If the communication audio signal is received from another aircraft or from a substantially stationary source relative to the receiving aircraft, then source position system 110 detects the location of the transmitting aircraft or the substantially stationary source. Source position system 110 detects the location of the transmitting aircraft or the substantially stationary source by employing a GPS system, radar system, IFF system, and the like or by receiving the location information from the transmitting source.

In procedure 508, a listening position is detected. This detected position defines the position of the ears of the listener (i.e., the crew member). With reference to FIG. 2, helmet line-of-sight system 204 detects the position of helmet 200, which defines the position of the ears of the user wearing helmet 200. If a warning indication has been received (procedure 500), then helmet line-of-sight system 204 detects the location and orientation of helmet 200 (i.e., the line-of-sight of the receiving crew member). If a communication audio signal has been received from another crew member in the same aircraft (procedure 504), then helmet line-of-sight system 204 detects the location and orientation of helmet 200. For example, when the crew member is inspecting the aircraft while moving there within, the helmet line-of-sight system detects the location and orientation of the crew member at any given moment. If a communication audio signal has been received from another aircraft or a substantially stationary source (procedure 504), then it is sufficient for helmet line-of-sight system 204 to detect only the orientation of helmet 200 of the receiving crew member, relative to the coordinate system of the receiving aircraft.

In procedure 510, the aircraft position is detected. The detected position defines the position of the aircraft in the global coordinate system. With reference to FIG. 1, if a communication audio signal has been received from a source external to the aircraft (e.g., another aircraft or a substantially stationary source), then aircraft position system 114 detects the location of the receiving aircraft, relative to the location of the transmitting aircraft or the substantially stationary source. Aircraft position system 114 detects the location by employing a GPS system, inertial navigation system, radar system, and the like. Alternatively, the position information can be received from the external source.

In procedure 512, an HRTF is selected. The HRTF is selected with respect to the relative position of the listener ears and the transmitting source. With reference to FIG. 1, if a warning indication has been received (procedure 500), then digital signal processor 118 selects an HRTF model, according to the retrieved warning location (procedure 502) and the detected line-of-sight of the receiving crew member (procedure 508). If a communication audio signal has been received from a transmitting crew member in the same aircraft (procedure 504), then digital signal processor 118 selects an HRTF model, according to the detected location of the helmet of the transmitting crew member (procedure 506) and the detected line-of-sight (location and orientation) of the receiving crew member (procedure 508). If a communication audio signal has been received from another aircraft or a substantially stationary source, then digital signal processor 118 selects an HRTF model, according to the location detected in procedure 506, the line-of-sight detected in procedure 508 and the location of the receiving aircraft detected in procedure 510.

In procedure 514, the selected HRTF is applied to the audio signal, thereby producing a plurality of audio signals. Each of these audio signals is respective of a different position in three dimensional space. With reference to FIG. 1, digital signal processor 118 applies the HRTF model which was selected in procedure 512, to the received warning indication (procedure 500), or to the received communication audio signal (procedure 504).

Digital signal processor 118 further produces a left channel audio signal and a right channel audio signal (i.e., a stereophonic audio signal). Digital signal processor 118 provides the left channel audio signal and the right channel audio signal to left channel sound reproducer 122 and right channel sound reproducer 124, respectively, via DAC 120. Left channel sound reproducer 122 and right channel sound reproducer 124 produce a left channel sound and a right channel sound, according to the left channel audio signal and the right channel audio signal, respectively (procedure 516).

It is noted that the left and right channel audio signals include a plurality of elements having different frequencies. These elements generally differ in phase and amplitude according to the HRTF model used to filter the original audio signal (i.e., in some HRTF configurations, for each frequency). It is further noted that the digital signal processor can produce four audio signals in four channels for four sound reproducers (quadraphonic sound), five audio signals in five channels for five sound producers (surround sound), or any number of audio signals for respective number of sound reproducers. Thus, the reproduced sound can be multi-dimensional (i.e., either two dimensional or three dimensional).

In a further embodiment of the disclosed technique, the volume of the reproduced audio signal, is altered so as to indicate distance characteristics for the received signal. For example, two detected threats, located at different distances from the aircraft, are announced to the crew member using different volumes, respective of the distance of each threat. In another embodiment of the disclosed technique, in order to enhance the ability of the user to perceive the location and orientation of a sound source, the system utilizes a predetermined echo mask for each predetermined set of location and orientation. In a further embodiment of the disclosed technique, a virtual source location for a received transmission is selected, based on the originator of the transmission (i.e. the identity of the speaker, or the function of the radio link). Thus a crew member may identify the speaker, or the radio link, based on the imbued virtual source location.

For example, transmissions from the mission commander may be imbued with a virtual source location directly behind the crew member, whereas transmissions from the control tower may be imbued with a virtual source location directly above the crew member, allowing the crew member to easily distinguish between the two speakers. In another example, radio transmissions received via the ground support channel, may be imbued with a spatial location directly beneath the crew member, whereas, tactical communications received via a dedicated communication channel may be imbued with a virtual source location to the right of the crew member.

It is noted that the locations and sources, described herein above are merely examples of possible locations and sources, provided to illustrate the principles of the disclosed technique. Other virtual source locations and communication sources may be used, as required.

In a further embodiment of the disclosed technique, the method illustrated in FIG. 5, further includes a preliminary procedure of constructing HRTF models, unique to each crew member. Accordingly, the HRTF models used for filtering the audio playback to the crew member, are loaded from a memory device that the crew member introduces to the system (e.g., such a memory device can be associated with his or her personal helmet). It is noted that such HRTF models are generally constructed in advance and used when required.

In a further embodiment of the disclosed technique surround sound speakers are used to reproduce the audio signal to the crew member. Each of the spatial models corresponds to the characteristic of the individual speakers and their respective locations and orientations within the aircraft. Accordingly, such a spatial model defines a plurality of audio channels according to the number of speakers. However, the number of audio channels may be less than the number of speakers. Since the location of these speakers is generally fixed, then a spatial model is not selected according to the crew member line-of-sight (LOS) information, but only based on the source location and orientation with respect to the volume defined and surrounded by the speakers. It is noted that in such an embodiment, the audio signal is heard by all crew members in the aircraft, without requiring LOS information for any of the crew members.

It will be appreciated by persons skilled in the art that the disclosed technique is not limited to what has been particularly shown and described herein above. Rather the scope of the disclosed technique is defined only by the claims, which follow.

1. System for producing multi-dimensional sound to be heard by an aircraft crew member, the multi-dimensional sound being respective of at least one input signal received from at least one source and associated with a respective indicated input signal position, the system comprising:
an aircraft crew member position system, detecting said aircraft crew member position;
a memory unit, storing at least a plurality of spatial sound models;
a processor, coupled with said aircraft crew member position system, said memory unit and with said at least one source, said processor retrieving a selected one of said spatial sound models from said memory unit, according to said indicated input signal position and said aircraft crew member position, said processor applying said selected spatial sound model to an audio signal respective of said at least one input signal, thereby producing a plurality of audio channels; and
a plurality of head-mounted sound reproducers, coupled with said processor, each said head-mounted sound reproducers being associated with and producing sound according to a respective one of said audio channels.

2. The system according to claim 1, wherein said at least one input signal is a warning indication.

3. The system according to claim 1, wherein said at least one input signal is respective of the state of a component of the aircraft.

4. The system according to claim 1, wherein said at least one input signal is respective of the voice of a transmitting user.

5. The system according to claim 1, wherein said at least one input signal is a radio signal.

6. The system according to claim 1, wherein said indicated input signal position is respective of at least one preferred position of said at least one input signal.

7. The system according to claim 1, wherein said aircraft crew member position system is selected from the list consisting of:
electromagnetic detection system;
optical detection system; and
sonar system.

8. The system according to claim 1, wherein said aircraft crew member position system is coupled with a head-mounted device.

9. The system according to claim 8, wherein said head-mounted device is selected from the list consisting of:
helmet;
headset;
goggles; and
spectacles.

10. The system according to claim 1, wherein each of said spatial sound models is a head related transfer function.

11. The system according to claim 1, wherein the phase and frequency of each of said audio channels is respective of a selected one of said spatial sound models.

12. The system according to claim 1, wherein each of said spatial sound models is respective of the distance of said at least one source from said aircraft crew member.

13. The system according to claim 1, wherein said spatial sound models are respective of said aircraft crew member.

14. The system according to claim 1, wherein each of said spatial sound models is respective of the source type of said at least one input signal.

15. The system according to claim 1, wherein said aircraft crew member position system further comprises an aircraft position system coupled with said processor, and
wherein said aircraft position system detects the position of said aircraft.

16. The system according to claim 1, wherein the type of said aircraft is selected from the list consisting of:
airplane;
helicopter;
amphibian;
balloon;
glider;
unmanned aircraft; and
spacecraft.

17. The system according to claim 1, further comprising a source position system coupled with said processor, wherein said source position system detects said indicated input signal position.

18. The system according to claim 1, further comprising a signal interface coupled with said processor, said signal interface receiving said at least one input signal.

19. The system according to claim 18, wherein said signal interface multiplexes said at least one input signal.

20. The system according to claim 1, further comprising a radio receiver coupled with said processor, wherein said radio receiver receives said at least one input signal.

21. The system according to claim 1, further comprising an audio object memory coupled with said processor, wherein said audio object memory includes information respective of said indicated input signal position and of an alarm state respective of said at least one input signal.

22. The system according to claim 1, further comprising a multi channel analog to digital converter coupled with said processor, wherein said analog to digital converter converts analog ones of said at least one input signal from analog format to digital format.

23. The system according to claim 1, further comprising a digital to analog converter coupled with said processor and with said head-mounted sound reproducers, wherein said digital to analog converter converts signals received from said processor, from digital format to analog format.

24. The system according to claim 1, wherein said indicated input signal position is defined relative to said aircraft crew member position.

25. Method for producing multi-dimensional sound to be heard by an aircraft crew member, the method comprising the procedures of:
detecting a listening position of said aircraft crew member;
selecting a spatial sound model according to said detected listening position and an indicated audio signal position;
applying said selected spatial sound model to an audio signal, thereby producing a plurality of audio signals; and
producing said multi-channel sound by a plurality of head-mounted sound reproducers, according to said audio signals.

26. The method according to claim 25, further comprising a preliminary procedure of retrieving said audio signal and said indicated audio signal position from a memory unit, said audio signal and said indicated audio signal position being respective of an input signal.

27. The method according to claim 26, further comprising a preliminary procedure of receiving said input signal.

28. The method according to claim 25, further comprising a preliminary procedure of detecting said indicated audio signal position, said indicated audio signal position being respective of said audio signal.

29. The method according to claim 28, further comprising a preliminary procedure of receiving said audio signal.

30. The method according to claim 25, further comprising a procedure of detecting the position of the aircraft, before said procedure of selecting.

31. The method according to claim 25, wherein said selecting procedure is performed according to said detected listening position and the distance between said listening position and said indicated audio signal position.

32. The method according to claim 25, wherein said selecting procedure is performed according to said detected listening position and the source type of said audio signal.

33. The method according to claim 25, wherein said selecting procedure is performed according to the hearing characteristics of said aircraft crew member.

34. The method according to claim 25, wherein said selecting procedure comprises a sub-procedure of associating said indicated audio signal position with a preferred position of said audio signal.

35. The method according to claim 25, wherein said selecting procedure comprises a sub-procedure of associating the phase and frequency of each of said audio signals with said selected spatial sound model.

36. The method according to claim 25, further comprising a procedure of converting said audio signal from analog format to digital format, before said procedure of applying.

37. The method according to claim 25, further comprising a procedure of converting said audio signals from digital format to analog format, after said procedure of applying.

38. System for producing multi-dimensional sound in an aircraft, the multi-dimensional sound being respective of at least one input signal received from at least one source and associated with a respective indicated input signal position, the system comprising:
a memory unit, storing at least a plurality of spatial sound models;
a processor, coupled with said memory unit and with said at least one source, said processor retrieving a selected one of said spatial sound models from said memory unit, according to said indicated input signal position, said processor applying said selected spatial sound model to an audio signal respective of said at least one input signal, thereby producing a plurality of audio channels; and
a plurality of sound reproducers, coupled with said processor and located at substantially fixed positions within said aircraft, each said sound reproducers being associated with and producing sound according to a respective one of said audio channels.

39. The system according to claim 38, wherein said at least one input signal is a warning indication.

40. The system according to claim 38, wherein said at least one input signal is respective of the state of a component located in said aircraft.

41. The system according to claim 38, wherein said at least one input signal is respective of the voice of a transmitting user.

42. The system according to claim 38, wherein said at least one input signal is a radio signal.

43. The system according to claim 38, wherein said indicated input signal position is respective of at least one preferred position of said at least one input signal.

44. The system according to claim 38, wherein each of said spatial sound models is respective of the source type of said at least one input signal.

45. The system according to claim 38, wherein each of said spatial sound models is respective of the distance of said at least one source from said aircraft.

46. The system according to claim 38, further comprising a source position system coupled with said processor, wherein said source position system detects said indicated input signal position.

47. The system according to claim 38, further comprising a signal interface coupled with said processor, said signal interface receiving said at least one input signal.

48. The system according to claim 47, wherein said signal interface multiplexes said at least one input signal.

49. The system according to claim 38, further comprising a radio receiver coupled with said processor, wherein said radio receiver receives said at least one input signal.

50. The system according to claim 38, further comprising an audio object memory coupled with said processor, wherein said audio object memory includes information respective of said indicated input signal position and of an alarm state respective of said at least one input signal.

51. The system according to claim 38, further comprising a multi channel analog to digital converter coupled with said processor, wherein said analog to digital converter converts analog ones of said at least one input signal from analog format to digital format.

52. The system according to claim 38, further comprising a digital to analog converter coupled with said processor and with said sound reproducers, wherein said digital to analog converter converts signals received from said processor, from digital format to analog format.

53. The system according to claim 38, further comprising an aircraft position system coupled with said processor, wherein said aircraft position system detects the position of said aircraft.

54. The system according to claim 38, wherein said processor retrieves said selected spatial sound model from said memory unit, according to the location and the type of each of said sound producers.
